(19) United States
(12) Patent Application Publication
(10) Pub. No.: US 2011/0053623 A1
(43) Pub. Date: Mar. 3, 2011

(54) HFC BANDING FOR A VIRTUAL SERVICE GROUP

(75) Inventors: Luis Agustin Rovira, Atlanta, GA (US); Gary Marshall Springer, Alpharetta, GA (US); James A. Strothmann, Alpharetta, GA (US)

(73) Assignee: Cisco Technology, Inc., San Jose, CA (US)

(21) Appl. No.: 12/553,379

(22) Filed: Sep. 3, 2009

(51) Int. Cl. H04B 7/00; H04N 7/173

(52) U.S. Cl. 455/507; 455/509; 725/114

(57) ABSTRACT

Embodiments may be disclosed herein that provide systems, devices, and methods of creating and using virtual service groups on HFC networks. One such embodiment is a system comprising: a headend in communication with a plurality of consumer premises devices; contiguous or non-contiguous bands of QAM carriers; the plurality of consumer premises devices organized into virtual service groups and tuned to designated bands of data corresponding to the virtual service group to which each consumer premises device is assigned.

### FIELD OF THE DISCLOSURE

The present disclosure relates to bandwidth management, and more specifically, to systems and methods of making better use of the Hybrid Fiber Coaxial (HFC) spectrum.

### BACKGROUND

Today, agile tuners in HFC receivers may be slow and can limit the content available to a customer. Physical service groups may be inflexible and cannot be defined based on certain characteristics, such as demographics. Physically subdividing service groups is expensive. Out-of-band tuners can add cost and complexity to the HFC receivers. There is a need for a more efficient grouping solution.

### BRIEF DESCRIPTION OF THE DRAWINGS

The accompanying drawings, which are incorporated herein constitute a part of this disclosure, illustrate various embodiments of the present invention. In the drawings:

FIG. 1 is a block diagram of an environment in which embodiments of the present invention may be located.

FIG. 2 is a block diagram showing embodiments of an SDV system in which embodiments of the present invention may be located.

FIG. 3 illustrates embodiments of the present invention.

FIG. 4 illustrates embodiments of the present invention.

FIG. 5 is a flow diagram illustrating operation of embodiments of the present invention.

FIG. 6 is a flow diagram illustrating operation of embodiments of the present invention.

Both the foregoing general description and the following detailed description provide examples and are explanatory only. Accordingly, the foregoing general description and the followed detailed description should not be considered to be restrictive. Further, features or variations may be provided in addition to those set forth herein. For example, embodiments may be directed to various feature combinations and sub-combinations described in the detailed description.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Switched Digital Video (SDV) may help to uncouple the correspondence between HFC bandwidth and offered content. However, SDV has always been tied to physical service groups (also called TSID groups). Spectral bands may be used with HFC for analog, digital, data and other types of services. Such spectral bands may be employed by embodiments of the present invention to differentiate service groups.

HFC-connected homes may contain a service gateway which may house a number of RF tuners and may act as a server to a number of IPTV set-top boxes and other consumer premises equipment. Certain embodiments of the service gateway may specify multiple frequency agile tuners which may be capable of tuning the entire HFC spectrum.

It may be advantageous to use a block converter. Such a block converter may be capable of block converting a plurality of QAM carriers. QAM stands for quadrature amplitude modulation, a frequency division multiplexing technique. One such embodiment of the block converter may be capable of handling 16 such QAM carriers. A demodulator following the block converter may digitize and demodulate the entire block, or just some selected carriers within the block. The selected carriers form a group. Carriers within the group need not be contiguous. A group of 16 QAM carriers for example may represent an entire 100 MHz block. A group of 8 carriers for example may represent every other carrier in the 100 MHz block.

Through the use of active SDV technology or passive VBR stat-muxing of channel streams, all of the available channels may be offered over such a group of channel streams to a plurality (e.g., 100s) of client devices. These client devices may include IPTV set top boxes capable of receiving the channels and displaying them upon selection of a channel by a consumer.

Such usage of a carrier groups may allow for the creation of HFC bands of n QAM carriers which may or may not be contiguous. Homes which may be located within physical service groups may be assigned to tune to these bands. Homes which may be tuned to a common band of n QAMs may form virtual service groups (VSG) which may be selected on demographic or other bases rather than by the usual physical constraints. Different virtual service groups may be treated differently with respect to services or advertisements offered or quality of service.

The bands may be reconfigured as needed. Tuners receiving carriers in these bands may be used in agile tuning mode, but in some embodiments the tuners may operate in a static tuning mode. In some embodiments, at the headend content may be placed by the headend system into a specific band that the related service gateway may already be tuned to. This may result in faster tuning and channel changing. Such a system may also provide for a decoupling of the content quantity simultaneously being consumed by the home from the number of tuners in the set-top boxes or the service gateway.

Embodiments may be disclosed herein that provide systems, devices, and methods of creating and using virtual service groups. One such embodiment is a system comprising: a headend in communication with a plurality of consumer premises devices and capable of directing content into selected bands of QAM carriers; a plurality of consumer premises devices organized into virtual service groups and tuned to receive the bands of carriers corresponding to the virtual service group to which each consumer premises device is assigned by the headend.

Some embodiments may include a method comprising: logically grouping a plurality of QAM carriers into a plurality of bands; assigning properties such as for example demographic properties to each band; provisioning a plurality of consumer premises devices to tune to common bands; storing the virtual service group allocation information in memory associated with the set-top box or gateway; and forming virtual service groups with the determined plurality of consumer premises devices tuned to common bands.

Some embodiments may include a method comprising: the headend receiving a request for content from a gateway or set-top box; determining a virtual service group associated with a gateway or set-top box located at a consumer residence; directing the content to be transmitted over a QAM carrier in the band associated with that virtual service group; and the set-top box or gateway receiving the content over the band of QAM carriers associated with a channel band in the virtual service group.

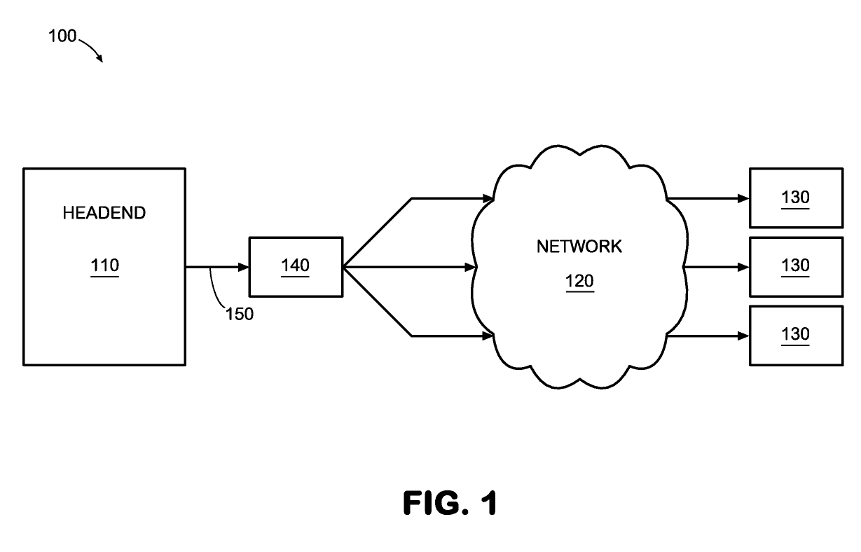

FIG. 1 illustrates a system containing embodiments of the present invention. A HFC network 100 may consist of a head-end location 110 where all incoming signals may be received from a plurality of sources. Regardless of their source, frequency-division multiplexing (FDM) may be applied to the signals. The signals may subsequently be amplified and transmitted downstream across network 120 for distribution to a plurality of homes 130. Each home may contain a plurality of consumer premises devices. The cable plant may be improved by the introduction of fiber-optic technology.

Portions of the coaxial cable 150 and supporting amplification elements may be replaced with multifiber optic cable 140 from head-end 110 or a hub location. The aggregated video signal may be used to modulate a downstream laser, which may transmit the optical signal to an optical node, which in turn may convert the signal from an optical to an electrical signal that can then be propagated downstream to the entire customer serving area 130.

The introduction of the fiber may significantly reduce the number of cascaded amplifiers required and consequently improve overall network 100 reliability, the signal-to-noise ratio (SNR) of the downstream video signal, and potential system bandwidth. Two-way operation may be achieved by the addition of requisite upstream amplifiers in the amplifier housings, the addition of a narrow-band upstream laser in the optical node, a dedicated upstream fiber to the head end, and a compatible optical receiver to convert any upstream information to an electrical signal.

HFC network 100 may increase available bandwidth in the downstream or forward direction from the head-end 110 or hub to a customer 130. Downstream channel bandwidths may be determined by the individual country's video broadcast standards or other factors.

A challenge may be to realize sufficient usable upstream bandwidth to achieve the systems throughput requirements for data or other services. The limited upstream bandwidth may often be shared with other services, ranging from impulse pay-per-view (IPPV), telemetry, and alarm gathering information from the active elements in the cable plant, as well as having to compete with interfering signals that radiate into the lower frequency range.

Many cable companies offer a wide range of services, including cable television programming, digital video and audio channels, high definition (HD) television channels, video on demand (VOD), cable modem Internet services and digital phone service. While HFC systems may have a relatively large bandwidth capacity, service may suffer if too many customers are using it at the same time. One solution may be the use of Switched Digital Video (SDV).

In older cable systems, the cable company may broadcast every channel in a single stream of programming to every section of its network all the time. When a set-top box (STB) tunes to a particular channel, the STB may search the stream for the channel's frequency and subsequently carry the signal to a television.

Because the cable company sent every channel through the entire network, there may not be much spare bandwidth available for Internet service or digital video channels. High definition channels may take up more bandwidth than normal digital video, so spare bandwidth decreases as cable companies add HD channels to their lineups.

Switched digital video may use a different delivery system. Instead of combining all channels into one programming stream throughout the network, the cable company may select only the most popular channels for a network-wide stream. For less popular programming, the company may respond to individual customer demands as the customer tunes in to that channel. In other words, the service provider may send only the channels customers are actually trying to watch. Because the system only sends customer-demanded channels, there may be spare bandwidth left over for other services.

Providing only the requested channel feeds would free up enough bandwidth for the cable company to increase the number of available channels in any given region, including HD video feeds. Furthermore, channel selection may be customized for different regions, including niche programming that might appeal to one segment of the company's customer base but not another. Such created bands of channels may be assigned to virtual service groups comprising a plurality of consumers.

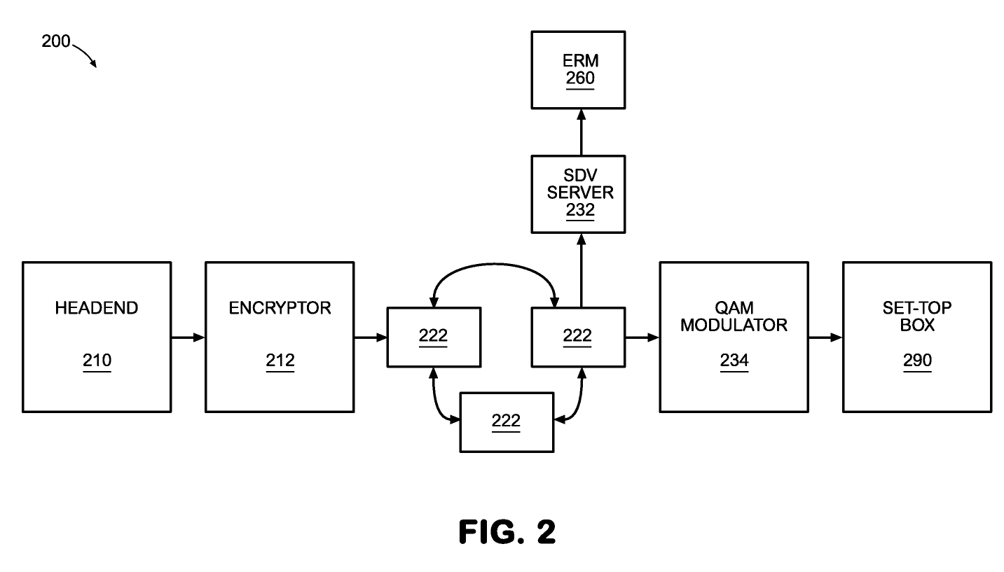

FIG. 2 illustrates an embodiment of an SDV system. SDV system 200 may comprise a headend 210, a transport system, an access system and a customer network. The headend 210 of SDV 200 may be where the video and Internet feed sources enter the system 200. Headend 210 comprises much of the equipment at a cable company. Such equipment may include MPEG encoders, which convert the raw digital or analog signal into an MPEG format.

An encryptor 212, may scramble the signal in such a way that only an authorized set-top box 290 (STB) may unscramble it. Internet servers may allow customers to access the Internet using cable modems. Applications servers, including an Edge Resource Manager (ERM) 260, may determine how much system bandwidth each application can access. SDV server 232 may monitor and manage channel change requests.

Some elements of the headend 210 may only flow one way into the system 200, such as the cable company's video feed. Other applications servers may communicate back and forth with the network to ensure that everything is running correctly.

Once headend 210 converts the video feed into MPEG format and encrypts it, it may send the signal on to the transport system of the SDV 200 architecture. The transport system may route the video and Internet feeds from the cable company to the access system. The transport system may also consist of a plurality of nodes 222. The nodes 222 may be points where cable connections intersect and branch off. In some embodiments the nodes 222 may be routers. Nodes 222 may redistribute the signal to other nodes 222 and routers so that the original feed may reach the cable company's entire customer base. The transport system's path may connect headend 210 to the access system.

The access system may be where digital switching may take place. The core of the access system may be a SDV server 232. SDV server 232 may keep track of a customer's channel change requests. SDV server 232 may be dedicated computers that run software designed to interpret each channel request. SDV server 232 may send commands to an Edge Resource Manager (ERM) and several QAM devices 234 to meet customer demands. The technique may allow cable companies to transmit digital signals more efficiently by using 90-degree phase and amplitude modulation on a radio frequency carrier to send multiple signals across the same line. This group of signals may be assigned to a virtual service group including a plurality of consumer premises.

Such QAM modulation schemes may use any constellation level (e.g. QAM-16, QAM-64, QAM-256 etc.) depending on the details of a cable access network. A QAM may also refer to a physical channel modulated according to such schemes. Typically, a single QAM modulator 234 can output a multiplex of ten or twelve programs, although the actual number may be dictated by a number of factors, including the communication standard that is employed. The edge QAM modulators 234 may be adapted to receive Ethernet frames that encapsulate the transport packets, de-capsulate these frames and remove network jitter, and transmit radio frequency (RF) signals representative of the transport stream packets to end users, over the HFC network. Each transport stream may be mapped to a downstream QAM channel. Each QAM channel within a common physical grouping has a carrier frequency that differs from the carrier frequency of the other channels. The transport streams may be mapped according to a virtual service group plan designed by a network system operator.

The customer network may include set-top box 290 that receives and decrypts signals from the access system and a cable modem if the customer subscribes to cable Internet service. Using SDV system 200, cable companies may get information about what their customers watch. For example, some SDV systems may offer systems that would allow a cable company to target specific regions, or even specific households, with local advertising based on viewing habits and other various demographics.

The cable version of Switched Digital Video (SDV) may be designed to operate over existing HFC infrastructures to enable delivery of switched video services on the existing installed base of set top boxes. Such set-top boxes may decode Moving Pictures Expert Group (MPEG) media streams and other types of digital media.

The set-top boxes may be in communication with a cable head end 210. Cable head end 210 may implement an SDV by allocating a number of logical channels to a number of physical channels that are provided by QAM modulators 234. Each of the physical channels may correspond to a different radio frequency that carries the logical channels. The physical channels may be assigned to specific virtual service groups. This radio frequency may be used by a tuner in set-top box 290 in order to tune to, and receive, the logical channels carried on the physical channel. The set-top box 290 may be assigned to a virtual service group tuned to designated physical channels.

The logical channels may carry media content (or media programming) such as broadcast media streams (i.e. video, audio, text, etc.) or video on demand (VoD), among other types of media streams. In many cable networks, media content is transmitted on the logical channels using MPEG (e.g., MPEG-2, MPEG-4, etc.) audio/video compression. The number of logical channels carried on a physical channel may be dependent upon the amount of bandwidth allocated to the channel and the allocated bitrate of each logical channel.

For broadcast logical channels, once content has been allocated by head end 210, this allocation information may be transmitted to set-top box 290 to provide a mapping of each of the logical channels to the physical channels as well as storing the identification of its associated virtual service group. Accordingly, when set-top box 290 is instructed to decode a particular logical channel, set-top box 290 consults this mapping to determine which physical channel the requested broadcast logical channel is being carried upon. Set-top box 290 may determine the virtual service group to which it has been assigned and tune to the associated physical channel and filter the particular logical channel by, for example, its unique program identifiers (PID), thereby extracting the desired content from other content received on any other logical channels.

Physical channels may be limited by the total amount of bandwidth provided by a cable operator. Thus for logical channels using SDV, SDV server 232 and ERM 260 typically only allocate logical channels to a particular physical channel if the logical channel is in use, or is likely to be used soon, by set-top box 290. In the event that a requested logical channel may not currently be provided on a particular physical channel, set-top box 290 may request SDV Server 232 to provide the particular logical channel. In such an instance, ERM 260 can allocate the logical channel to a selected physical channel and SDV Server 232 will notify set-top box 290 which physical channel and logical channel the media content is being provided on. Set-top box 290 can then tune to the physical channel and receive the desired media content.

Such an SDV set up may provide a large variety of potential media content to users without the need for broadcasting every single physical channel to every set-top box 290 at the same time through the use of virtual service groups. Thus, even though a particular cable system may only be able to physically provide 30% of the total available content to a particular neighborhood, a small subset of available logical channels may be used by the set-top box 290 in a particular virtual service group at any one time. Thus a Service Provider may provide a wide variety of content choices for their subscribers without the need for broadcasting every channel simultaneously.

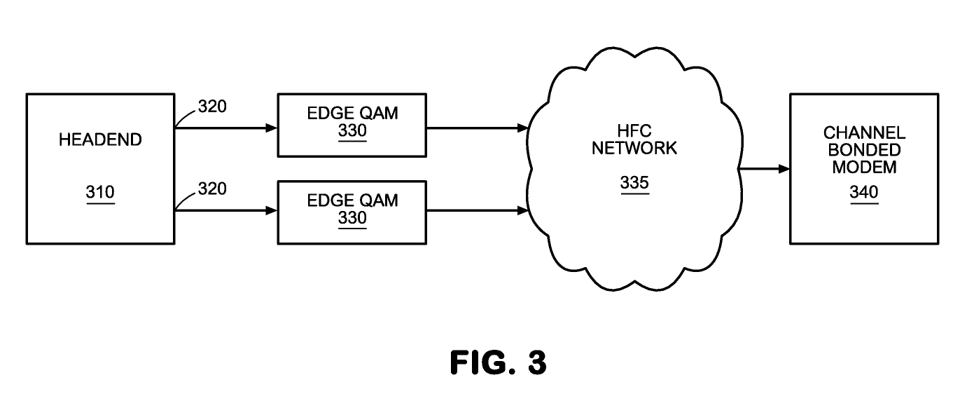

FIG. 3 illustrates embodiments of the present invention. Embodiments of the present invention may utilize video over DOCSIS (“V-DOC”) using IP protocol over QAM modulation per the DOCSIS standard. V-DOC may better optimize network bandwidth availability by using channel bonding. A plurality of QAM carriers from the QAM modulators 330 may be logically bonded together for transmission as a channel group. The QAM modulators 330 may be operating in an HFC network, such as HFC network 100. A head end 310 may deliver content to the QAM modulators 330. For example, 24 downstream physical QAM carriers (occupying an aggregate bandwidth of around 144 MHz) may be transmitted to channel bonded modems supporting transmission rates of almost 1 Gbps.

Headed 310 may contain a plurality of output interfaces 320. In some embodiments, each output interface 320 may provide IP connectivity to edge QAM modulator 330. Thus, the higher number of output interfaces 320 supported by head end 310, the higher the capacity for downstream channels. In some embodiments, QAM modulators 330 may be connected to headend 310 over multiple Gigabit Ethernet connections.

QAM modulators 330 may transmit the downstream channels through HFC network 335 and the channels may be received by channel bonding modems 340. Channel bonding modems 340 may use multiple channels to receive many media packets simultaneously. Channel bonding modems 340 may operate to reassemble packets as they are received from multiple QAM modulators 330.

In one embodiment, each channel bonding modem 340 may have a plurality of bonded channels. This may support in excess of 100 Mbps downstream data transfer over 256 QAM DOCSIS channels when operating with three or more bonded channels. Channel bonding modem 340 may receive packets over a plurality of parallel channels to STTs on behalf of other consumer network devices. Edge QAM modulators 330 may support a plurality of channel carriers, for example 24 downstream carriers. Groupings of these plurality of carriers may be assigned for transmission to virtual service groups containing a plurality of residences.

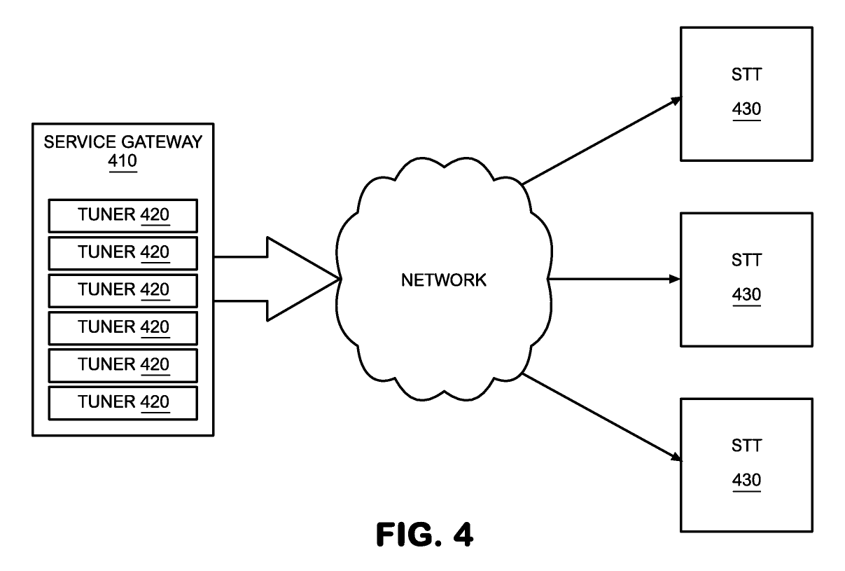

FIG. 4 illustrates embodiments of the present invention at a customer premise. In some embodiments of the present invention, a service group may be a virtual service group. Virtual service groups may be differentiated by the use of designated spectral bands on the HFC network.

A service gateway 410 may house a plurality of RF tuners 420. Service gateway 410 may act as a server to STTs 430 or other consumer premises equipment (“CPE”) that may be on a home network. Service gateway 410 may specify a plurality of frequency agile tuners 420 that may be capable of tuning into the entire HFC spectrum. The tuners 420 may receive a plurality of QAM carriers. The tuners 420 may subsequently digitize and demodulate the entire plurality of channels carried by the QAM carriers.

The use of active SDV technology as described in FIG. 2 may be used to group channels together into bands delivering content into virtual service groups. variable bit rate (VBR) statistical-multiplexing may enable a plurality of SDV signals to be statistically multiplexed in one or more QAM channels, while maintaining the video quality of the incoming VBR digital broadcast signals.

VOD and SDV signals and signals for other applications may be multiplexed through common QAM modulators and received by a service gateway 410 hardware platform that can support optimized Edge QAM sharing. Service gateway 410 may employ industry-standard open interfaces, allowing interoperability with any Session or Edge Resource Manager (SRM/ERM), Edge QAM device and/or application server.

The bonded group of channels may provide all of the content to a sufficiently small plurality of client devices, such as STTs 430. A plurality of HFC bands of N QAM carriers may then be created. Homes located in determined physical service groups may be assigned to tune to specific bands. QAM channels in the bands do not need to be contiguous in frequency.

Gateways 410 in each of the homes in the physical service group may tune to a common band of N QAM carriers. Virtual service groups may be created containing a plurality of such homes. Membership into the virtual service group may be based on demographics, advertising zones, service level or other bases rather than by physical constraints. In some embodiments, the service gateway 410 may contain tuners 420 operating on V-DOC. In that scenario, no out-of-band tuners may be required.

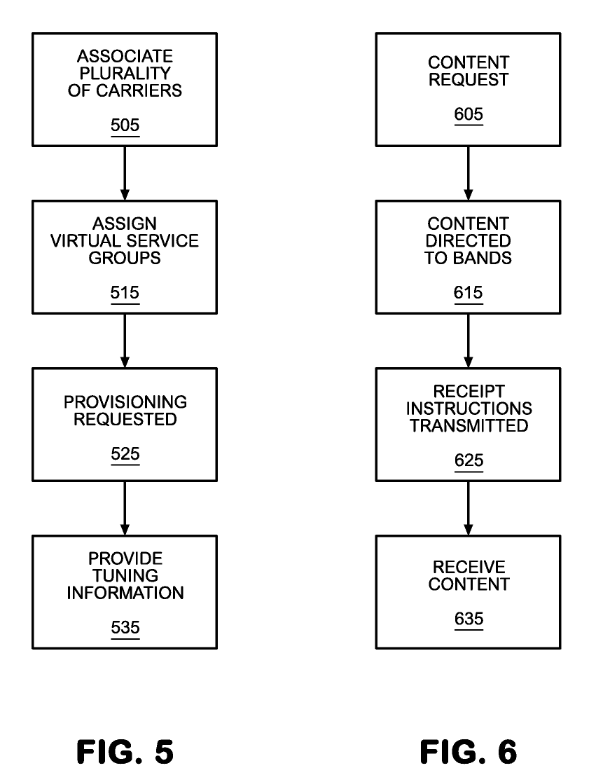

FIG. 5 illustrates a method of configuring embodiments of the present invention. The method may begin at step 505 in the headend where a number of QAM carriers may be associated wherein the QAM carriers may be feeding common physical groups into bands which in turn provide content to the virtual service groups.

Once the QAM carriers are associated, the method may next proceed to step 515. At step 515 the bands and virtual service groups may be assigned to categories such as demographics or service levels. For example, a virtual service group may be assigned for a group associated with a target demographic for particular advertising.

The method may then proceed to step 525 where a gateway or set-top box boots and requests provisioning on the network. At step 535, the headend provisions the set-top box or gateway with the tuning information required to tune to the spectral band associated with the virtual service group to which the set-top box or gateway has been assigned.

FIG. 6 illustrates a method of operating embodiments of the present invention. The method may begin at step 605 when a set-top box or gateway requests a service or content.

The method may then proceed to step 615 where the headend or SDV system directs content or services to be transmitted on the QAM carriers associated with the band feeding the virtual service group to which the requesting set-top box or gateway has been assigned.

The method proceeds to step 625 where the headend or SDV system informs the set-top box or gateway how to receive the content. In a system using IP, such as V-DOC, the information may include a multicast IP address. In a system not using IP the information may include frequency, TSID and program number.

The method proceeds to step 635 when the set-top box or gateway uses the provided information to receive the content or service. For example, television content may be received and displayed to a consumer.

Embodiments of the present invention may be embodied in any computer-readable medium for use by or in connection with an instruction execution system, apparatus, or device. Such instruction execution systems may include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example but not limited to, a system or that is based on electronic, magnetic, optical, electromagnetic, infrared, or semiconductor technology.

Specific examples of a computer-readable medium using electronic technology would include (but are not limited to) the following: random access memory (RAM); read-only memory (ROM); and erasable programmable read-only memory (EPROM or Flash memory). A specific example using magnetic technology includes (but is not limited to) a portable computer diskette. Specific examples using optical technology include (but are not limited to) compact disk (CD) and digital video disk (DVD).

Any software components illustrated herein are abstractions chosen to illustrate how functionality may be partitioned among components in some embodiments of the present invention disclosed herein. Other divisions of functionality may also be possible, and these other possibilities may be intended to be within the scope of this disclosure. Furthermore, to the extent that software components may be described in terms of specific data structures (e.g., arrays, lists, flags, pointers, collections, etc.), other data structures providing similar functionality can be used instead.

Any software components included herein are described in terms of code and data, rather than with reference to a particular hardware device executing that code. Furthermore, to the extent that system and methods are described in object-oriented terms, there is no requirement that the systems and methods be implemented in an object-oriented language. Rather, the systems and methods can be implemented in any programming language, and executed on any hardware platform.

Any software components referred to herein include executable code that is packaged, for example, as a standalone executable file, a library, a shared library, a loadable module, a driver, or an assembly, as well as interpreted code that is packaged, for example, as a class. In general, the components used by the systems and methods of reducing media stream delay are described herein in terms of code and data, rather than with reference to a particular hardware device executing that code. Furthermore, the systems and methods can be implemented in any programming language, and executed on any hardware platform.

The flow charts, messaging diagrams, state diagrams, and/or data flow diagrams herein provide examples of the operation of systems and methods of reducing media stream delay through independent decoder clocks, according to embodiments disclosed herein. Alternatively, these diagrams may be viewed as depicting actions of an example of a method. Blocks in these diagrams represent procedures, functions, modules, or portions of code which include one or more executable instructions for implementing logical functions or steps in the process.

Alternate implementations may also be included within the scope of the disclosure. In these alternate implementations, functions may be executed out of order from that shown or discussed, including substantially concurrently or in reverse order, depending on the functionality involved. The foregoing description has been presented for purposes of illustration and description. It is not intended to be exhaustive or to limit the disclosure to the precise forms disclosed. Obvious modifications or variations are possible in light of the above teachings. The implementations discussed, however, were chosen and described to illustrate the principles of the disclosure and its practical application to thereby enable one of ordinary skill in the art to utilize the disclosure in various implementations and with various modifications as are suited to the particular use contemplated. All such modifications and variation are within the scope of the disclosure as determined by the appended claims when interpreted in accordance with the breadth to which they are fairly and legally entitled.

What is claimed is:

1. A system comprising:
a headend in communication with a plurality of consumer premises devices;
a plurality of contiguous or non-contiguous groupings of modulated carriers forming bands that are assigned to groupings of consumer premises devices;
the plurality of consumer premises devices organized into virtual service groups and tuned to receive bands of carriers corresponding to the virtual service group to which each consumer premises device is assigned.

2. The system of claim 1, wherein the plurality of tuners are RF tuners.

3. The system of claim 1, wherein the bands of modulated carriers provide switched services to the customer premise devices.

4. The system of claim 1, wherein the bands of modulated carriers provide broadcast services to the customer premise devices.

5. The system of claim 1, wherein the bands of modulated carriers using quadrature Amplitude Modulation over a hybrid fiber-coax network.

6. The system of claim 1, wherein the bands of modulated carriers use VBR statistical multiplexing.

7. The system of claim 1, wherein the virtual service groups are defined by one of demographic characteristics or user watching patterns.

8. The system of claim 1, wherein the headend directs requested services and data into the band of modulators which is already tuned by a service gateway associated with the plurality of consumer premises devices.

9. A method comprising:
associating a plurality of data channels into a plurality of bands;
designating a plurality of consumer premises devices to tune to a common band;
forming a virtual service group with the determined plurality of consumer premises devices; and
transmitting to the consumer premises devices service group allocation information.

10. The method of claim 9, wherein the consumer premises devices are IPTV set-top boxes or gateways.

11. The method of claim 10, wherein the virtual service group is formed based on demographic information associated with the IPTV set-top boxes.

12. The method of claim 9, further comprising:
assigning each consumer premises device to a virtual service group based on a specific band tuned to by the service gateway associated with each consumer premises device.

13. The method of claim 9, wherein the bands are bands of HFC network bandwidth.

14. The method of claim 13, wherein each band of HFC network bandwidth contains a plurality of QAM channels.

15. A method comprising:
the headend receiving a request for service or content from a consumer premise device;
determining a virtual service group associated with the consumer premise device located at a consumer residence;
transmitting the content or service over a band associated with the virtual service group to which the consumer premise device has been assigned;
informing the consumer premise device how to receive the content or service; and
receiving the content or service over the band designated for its virtual service group at the consumer premise device.

16. The method of claim 15, further comprising:
utilizing video over DOCSIS to optimize bandwidth availability.

17. The method of claim 15, further comprising:
transmitting the requested content or service across a HFC network.

18. The method of claim 15, further comprising:
assigning a virtual service group to the set-top box through a service gateway comprising a plurality of tuners.

19. The method of claim 18, wherein the virtual service group is assigned based on demographic information associated with the set-top box.

20. The method of claim 19, further comprising:
using SDV to bond groups of channels into a plurality of virtual service groups.
